(19) United States
(12) Patent Application Publication
(10) Pub. No.: US 2014/0131634 A1
(43) Pub. Date: May 15, 2014

(54) BLENDED OIL COMPOSITIONS USEFUL AS DIELECTRIC FLUID COMPOSITIONS AND METHODS OF PREPARING SAME

(71) Applicant: E I DU PONT DE NEMOURS AND COMPANY, Wilmington, DE (US)

(72) Inventors: HARI BABU SUNKARA, HOCKESSIN, DE (US); WEIMING QIU, WILMINGTON, DE (US)

(73) Assignee: E I DU PONT DE NEMOURS AND COMPANY, Wilmington, DE (US)

(21) Appl. No.: 14/077,249

(22) Filed: Nov. 12, 2013

Related U.S. Application Data
(60) Provisional application No. 61/725,570, filed on Nov. 13, 2012.

(51) Int. Cl. H01B 3/20

(52) U.S. Cl. CPC H01B 3/20
USPC 252/578

(57) ABSTRACT

In the present invention, compositions that are suitable for use as dielectric fluids are obtained from renewably sourced oils, and blends thereof. Renewably sourced synthetic esters as described herein are prepared using components obtained from natural or biologic feedstocks, wherein the feedstocks can be regenerated via conventional farming techniques. Dielectric fluids that can meet the industry standards are obtained using a process of combining appropriate percentages of components selected from synthetic polyol esters, natural oils, and mineral oil to customize the properties of the dielectric fluid obtained. Some of the properties that can be manipulated in the practice of the present invention include: electrical strength, resistivity, impulse strength, dissipation factor, permittivity, specific heat, thermal conductivity, chemical stability, gas absorption, pour point, viscosity, volatility, flash and fire point, and biodegradability.

### FIELD OF THE INVENTION

This invention relates to dielectric fluid compositions suitable for use as electrical transformer insulation and cooling fluids.

### BACKGROUND

The electrical industry uses dielectric fluids for cooling electrical equipment such as transformers, power cables, breakers, and capacitors. Typically these dielectric fluids are used in combination with solid insulation in liquid-filled transformers. Examples include mineral oil, high molecular weight hydrocarbons (HMWH), silicone fluid, and synthetic hydrocarbon oils (polyalpha-olefins). Such fluids must be electrically insulating, resistant to degradation, and be able to act as a heat transfer medium so that the high amount of heat generated in an electrical apparatus can be dissipated to the surrounding environment and thereby increases the life of solid insulation.

However, mineral oil-filled transformers are typically not used inside of buildings due to concerns over safety, the environment, and for consideration of the special containment required.

Standards have been developed to qualify dielectric fluids as suitable for use in various equipment. The American Society for Testing Materials has developed ASTM Standards D3487-88 and D522292 which set specification limits for mineral insulating oils and high fire-point insulating oils of hydrocarbons. ASTM D6871-03 sets specification limits for natural ester fluids used in electrical apparatus, International Electrotechnical Commission Standard IEC 61099 sets specification limits for synthetic ester fluids and IEC 60296 Edition 4 sets specification limits for uninhibited mineral oils.

Additives are added often to the dielectric fluids to enhance the performance of the fluids and thereby increase the life of electrical distribution and power transformers. One common practice is the addition of oxidation inhibiting additives to the uninhibited oils. Another common practice is the addition of anti-gassing additives to fluids that have a positive gassing tendency. Dielectric fluids used in transformers, for example, can produce gas during the course of use, which can create pressure issues if used inside of a closed container. Also, the performance of the cooling fluids can be affected by the presence of gas bubbles in the fluid. United States Patent Pub. 2010/0279904 A1 describes an electrical insulating oil comprising a heavy reformate as an anti-gassing agent.

Use of conventional dielectric fluids is not trouble free. In recent years regulatory agencies have become increasingly concerned about oil spills which can contaminate the ground soil and other areas. Many of the conventional fluids are not biodegradable in a reasonable time frame. Some have electrical properties which render them less than optimal. A biodegradable dielectric fluid would be desirable for electrical apparatus such as transformers used in populated or ecologically sensitive areas.

Natural and synthetic esters can be used as dielectric fluids to replace mineral oils for safety and environmental reasons. Published Canadian Patent Application CA 2,492,565 discloses a dielectric coolant having at least a pour point of about −40° C. and comprising a mixture of more than one polyol ester of specified chemical structures, wherein the alkyl groups have chain lengths of C₅ to C₂₂. U.S. Pat. No. 8,187,508 B2 describes a base agent for electrical insulating oils mainly containing an esterified product of glycerin and a linear or branched fatty acid having 6-14 carbon atoms.

It is known that the oxidative stability of natural esters can be improved by (1) reduction in the number of double bonds (unsaturation) by complete or partial hydrogenation and/or by (2) reducing the polyunsaturation in an oil. However while either process can enhance the oxidative stability of a natural oil, such measures can increase the pour point of the oil, and this result is not desirable for oils used in transformers that are exposed to low ambient temperatures.

There is a continuing need for biodegradable electrical cooling fluids having good oxidative stability, that remain fluid at low temperature and stable at high temperature, or otherwise retain their desirable properties at temperature extremes. Further, it can be desirable to obtain transformer dielectric cooling fluids from renewably sourced materials.

There is also a need for methods of controlling the properties of biodegradable electrical cooling fluids that will ensure that they remain fluid and stable under a range of temperatures.

### SUMMARY

In one aspect, the present invention is a composition useful as a dielectric fluid, the composition being a blend comprising: (i) from about 50 wt % to about 99 wt % of mineral oil, based on the weight of the fluid; (ii) from about 1 wt % to about 50 wt % of a triacylglycerol natural oil obtained from a natural source, consisting essentially of long chain fatty acid esters having greater than about 75 mol % monounsaturation; and (iii) optional additives;

wherein the blend—without added aromatic anti-gassing additives—has a reduced gassing tendency compared to the gassing tendency of component (i).

In another aspect, the present invention is an electrical apparatus comprising a dielectric fluid of the present invention.

### BRIEF DESCRIPTION OF THE FIGURE

FIG. 1 is a graph of Oil Stability Index (OSI) versus Percentage of high oleic soybean oil in the blended composition.

### DETAILED DESCRIPTION

In one embodiment, the present invention is a composition that is useful as a dielectric fluid comprising a synthetic, renewably sourced polyol ester. The synthetic ester can either be used alone or as a blend with other natural oils, such as triacylglycerol oils and/or mineral oil.

Renewably sourced synthetic polyol ester fluids of the present invention are synthetic inasmuch as they are obtained by an esterification/transesterification ((trans)esterification) reaction or process under controlled process conditions. The (trans)esterification reaction may be conducted by any known conventional or nonconventional means, including the use of catalysts that can be acidic, basic, or enzymatic. In one embodiment, no added catalyst is required because the reaction can be self-catalytic under certain conditions.

For example, it is well established that esterification of an alcohol can be accomplished by contacting the alcohol with a carboxylic acid, or a derivative thereof, under suitable conditions to form a carboxylic ester. In some embodiments, when starting with a carboxylic acid the process can be catalyzed using an acid catalyst—for example a strong mineral acid such as hydrochloric acid, phosphoric acid, sulfuric acid, or other such strong protic acids that are well-known and conventional in the chemical art such as p-toluenesulfonic acid. Lewis acids can be suitable for the esterification process that can provide the synthetic oils of the present invention. Lewis acids such as, aluminium, titanium and tin compounds (such as tin(II) chloride dihydrate and dibutyl tin oxide) are known and conventional for such processes.

In other embodiments, the esterification of an alcohol can be accomplished using excess of carboxylic acid to ensure complete esterification, and no added catalyst. The excess fatty acid can be stripped off completely after the reaction under reduced pressure. If not, the residual acids present in the product can impact the properties such as oxidative stability, hydrolytic stability, power factor and other characteristics, and therefore the quality of the product should be improved. Refining the oil can be effective to improve the oil quality. This is particularly important when the reacting carboxylic acid is short or medium chain fatty acid.

In addition to carboxylic acids, the esters of the present invention can be obtained using carboxylic acid derivatives such as carboxylic acid halides, for example carboxylic acid chlorides and bromides. Carboxylic acid anhydrides or esters can also be useful derivatives of carboxylic acids to produce the synthetic esters of the present invention. In another embodiment, natural oils and/or esters can be suitable sources for the carboxyl group (also referred to herein as the “acyl” group) of the synthetic esters of the present invention, and can be used in a conventional process known as transesterification, wherein the acyl group of an the starting ester is transferred to a different hydroxyl-containing compound to form a different ester, and wherein the transesterification reaction is catalyzed by typical esterification catalysts.

The carboxylic acids or derivatives used in the practice of the present invention to prepare the synthetic esters of the present invention comprise from 6 to 12 carbon atoms. Carboxylic acids or derivatives having from 6 to 12 carbon atoms are referred to herein as medium chain acids or derivatives. For the purposes of the present invention, carboxylic acids and derivatives having carbon chain lengths of 14 or more are considered long-chain acyl compounds.

The synthetic medium chain polyacyl esters of the present invention comprise or consist essentially of saturated fatty acid carbon chains. That is, there are essentially no carbon to carbon multiple bonds. For example, hexanoic acid, octanoic acid, decanoic acid, dodecanoic acid, derivatives thereof as set forth hereinabove, and mixtures of any of these can be suitable for use in the practice of the present invention.

It can be conventional to refer to acids found in nature by common names. For the avoidance of doubt, linear saturated acids, and derivatives thereof, having from 6-12 carbons are suitable for use herein regardless of the name used to describe them. For example, hexanoic acid is also known as caproic acid, octanoic acid is known as caprylic acid, decanoic acid is known as capric acid and dodecanoic acid is also known as lauric acid. Caproic acid (C6), for the purposes of the present invention, shall be considered a medium chain fatty acid, together with caprylic (C8), capric (C10) and lauric (C12) acids.

The synthetic esters of the present invention are prepared from renewably sourced materials. For example, renewably sourced medium chain carboxylic acids can be obtained from a natural source such as palm kernel oil or coconut oil, which naturally comprises a large proportion of the medium chain fatty acids suitable for use herein. The oil obtained from palm kernels and coconut can be hydrolyzed by conventional methods known to those of ordinary skill in the edible oil industry, and the medium chain carboxylic acids fractionated—that is, separated from higher chain acids—by known methods such as distillation or separation based on molecular weight or polarity differences, and used to prepare the synthetic esters of this invention from suitable polyols.

The synthetic esters of the present invention are prepared by reacting a polyol with a mixture of medium chain fatty acids. The percentage of each medium chain fatty acid in the mixture can be tailored to provide an ester with properties that are desirable, but any one of the individual medium chain fatty acids can comprise from about 5 to about 90% of the mixture used to prepare the synthetic ester, with the caveat that at least about 95% of the total ester linkages of the synthetic ester comprise medium chain esters, the residual esters being short and/or long chain esters. In one embodiment, at least about 90% of the ester linkages of the synthetic ester comprise a mixture of caprylyl, capryl and/or lauryl esters.

It has been discovered herein that compositions derived from carboxylic acids and derivatives thereof that conform to these parameters can provide a balanced set of desirable properties that enhance the performance of the synthetic esters and blends thereof, particularly when used as dielectric cooling fluids.

While the presence of carbon-carbon multiple bonds in the synthetic esters of the present invention is not preferred, it is not outside of the contemplated scope of the present invention that the synthetic esters of the present invention may not achieve 100% purity in this regard. Therefore, it is intended in the presently claimed invention that such functionality be kept to a minimum, taking into account such factors as the cost and practicality of eliminating carbon-carbon multiple bonds completely, and the benefit gained from such measures, particularly in view of the other components that may be present in the claimed composition that may comprise unsaturated components. The synthetic esters of the present invention comprise less than 5 mol % of unsaturated esters, preferably less than 3 mol % and more preferably less than 1 mol %.

The synthetic esters of the present invention are obtained from reaction of the medium chain carboxyl components with a polyhydroxyl component, which can include polyhydroxy alcohols having at least three hydroxyl functional groups per molecule. For the purposes of the present invention, such polyhydroxyl alcohols may be alternatively referred to herein as “polyols”. Polyols of the present invention can be monomeric polyfunctional alcohols such as glycerol or pentaerythritol (PE) or trimethylolpropane (TMP) or trimethylolethane (TME), or oligomeric alcohols—such as diglycerol, triglycerol, ditrimethylol propane, dipentaerythrtitol, for example—or mixtures thereof. Polyols of the present invention can include naturally occurring compounds such as sugars or sugar alcohols—including mono- and disaccharides and/or derivatives thereof—as a minor component. For example, sucrose, glucose, fructose, mannose, sorbitol, or starches and other cellulosic materials can be considered polyols suitable for use in the practice of the present invention. For the purposes of the present invention, there is no distinction intended between the terms “polyhydroxyl alcohol” and “polyol”, and the terms may be used interchangeably with no effect on the scope of the present invention intended. In one embodiment the polyol is unsymmetrical and does not include a hydrogen on the carbon adjacent to the hydroxyl-bearing carbon (that is, the β position) such as, for example, trimethylolpropane. In another embodiment the polyol is diglycerol, triglycerol, tetraglycerol or mixture thereof.

In another embodiment, the synthetic ester compositions of the present invention can be blended with natural oils. A blend of the present invention can comprise a suitable triacyl glycerol oil in a relative amount of from about 5 to about to about 90 wt % of the blend, with the renewably sourced synthetic ester providing from about 10 to about 95 wt % of the blend. Alternatively, the blend can comprise the triacyl glycerol in an amount of from about 10 to about 80 wt %, or from about 10 to about 70 wt %, or from about 20 to about 50 wt %, or from about 30 to about 40 wt %. In some applications it can be critical that the composition of the blend is tailored to provide a blend that can be classified as a K-class fluid, and in those applications where the relative amount of the triacyl glycerol component should be blended with the goal of providing a K-class dielectric fluid, the actual percentage of triacyl glycerol can be tailored to achieve a balance of desirable properties to meet that standard.

The blends of the present invention can comprise a triacylglycerol oil comprising esters of carboxylic acids that comprise or consist essentially of long chain acids. Long chain acid esters of glycerol can be obtained from natural or biologic sources, such as oil-producing crops including soy bean, canola, sunflower, palm, palm kernel, coconut, and other known sources of natural oils. The triacyl glycerol oil component of the presently claimed composition can be a mixture of oils. In one embodiment, suitable triacyl glycerol oil for use in the present invention have high, that is 60 mol % or more, monounsaturated ester content. For example, oil high in monounsaturated content can be obtained from natural sources that provide high oleic acyl (oleyl) composition, such as the soy bean oil described in U.S. Pat. No. 5,981,781, which is incorporated herein by reference as if completely set out. Such high oleic soybean (HOS) oil has a high oleyl (C18:1) content of 75 mol % or more of the acyl component, with a combined polyunsaturated ester (C18:2 and C18:3) content of less than 10 mol %. Other natural oils having high oleic acid content are: sunflower oil, safflower oil, olive oil, and canola oil for example.

In another embodiment, natural esters having low to medium monounsaturated acid content can be suitable for use herein. For example, oils having from about 24 mol % to less than about 75 mol %—or alternatively from about 60 mol % to less than about 75 mol % monounsaturated acids—are considered having low to medium monounsaturation. Such oils include soybean oil, sunflower oil, safflower oil, and canola oil, for example.

In still another aspect of the present invention, any renewably sourced saturated polyol ester having desirable low and high temperature properties can be blended with natural esters so that the total unsaturation in the blend does not exceed an iodine value of 100. The preferred renewably sourced synthetic polyol esters are selected from glycerol based esters. trimethylolpropane based esters, glycerol oligomer based esters and mixtures thereof.

The blends of the present invention can provide surprising synergistic effects that are not readily predictable based on the properties of the individual components alone.

In the present invention, renewably sourced saturated synthetic polyol esters as described herein are prepared using fatty acid components obtained from natural or biologic feedstocks, wherein the feedstocks can be regenerated via conventional farming techniques.

Further, described herein is a methodology for obtaining a variety of cooling fluid compositions, wherein the cooling fluids have properties that are customized or tailored to meet the specific needs of the application.

Further described herein is an electrical insulating system comprising a dielectric cooling fluid and a solid electrical insulating material that can be customized to meet specific needs in various electrical operating systems, and a method of customizing said insulating system.

Ideally, dielectric cooling fluids used in transformers should have high dielectric strength, high volume resistivity (at least about 10¹¹ Ohm cm at 25° C. as determined by ASTM D-1169), high impulse strength, low dissipation factor, low viscosity, high specific heat, high thermal conductivity, excellent chemical stability and gas absorbing properties, good low temperature flow properties (low viscosity and low pour point), low volatility, high flash and fire points (non-flammable), non toxic, readily biodegradable, and available at low cost. Further, it can be desirable for the cooling fluid to have a dielectric constant (Dk) that is similar to solid insulation used in the electrical equipment. A single basestock fluid with all of the desired properties is difficult to provide. However, the fluid compositions of the present invention provide an overall balance of desirable properties in blended compositions that comprise renewably sourced polyol esters.

Dielectric cooling fluids described herein may be generically referred to using various alternate terms. For example, the terms “transformer oils”, “cooling fluids”, “insulating liquids” may be used generically to refer to dielectric cooling fluids, or other terms referring to the specific compositions of the presently claimed invention may be used interchangeably in the body of this specification. The contextual use of such terms herein should readily convey to one of ordinary skill such instances where a term is intended to be generic or where it is specific for a given use or composition.

The physical properties of the synthetic esters and blends of the present invention make them particularly suited for use as dielectric fluids. The ester compositions of the present invention can be formulated to embody a range of properties that balance desirable low temperature properties (for example, viscosity and pour point), high temperature properties (for example, flash and fire points), chemical stability (that is, thermal and oxidative stability) and electrical properties (for example, dissipation factor, dielectric constant), which are believed by the applicants to be critical to the performance of the synthetic ester compositions of the present invention. In addition, the gassing tendency of a dielectric fluid is a critical property of any dielectric fluid, because it is useful as a performance metric for suitable fluids to indicate whether they will be suitable under the conditions of use.

The low temperature properties of the compositions of the present invention are particularly useful in electrical transformers, which are generally exposed to variable atmospheric temperatures, including extremes in temperatures. Dielectric cooling fluids of the present invention have a pour point of lower than about −20° C., alternatively lower than about −30° C., or lower than about −40° C. as determined by ASTM D-97.

In addition, in order for cooling fluids to be efficient in their capacity as heat transfer fluids, it is desirable that the fluid have low viscosity, high thermal conductivity, high specific heat, and high expansion coefficient—particularly at transformer operating temperatures, which can range from temperatures below 0° C. to temperatures above 100° C. Of these properties, the viscosity is considered to be the more influential property for the heat transfer by either natural convection in smaller self-cooled transformers or forced convection in larger units with pumps. The generally accepted trend is: the lower the kinematic viscosity the higher the heat dissipation. Kinematic viscosity is the ratio of the dynamic viscosity of a liquid to its density.

Again, providing an ideal dielectric fluid is not without problems. Low viscosity fluids in general tend to have low flash and fire points and may not meet less flammable K-class standards. On the other hand, the fluids that meet K-class standards typically have higher kinematic viscosity, and typically are not as effective in dissipating the heat generated in liquid-filled transformers. This ineffective heat dissipation can contribute to shortening the life of the transformers. Insulating cooling fluids of the present invention have kinematic viscosity not greater than 40 cSt at 40° C. as determined by ASTM D-445, yet can meet the criteria of being K-class fluids.

Viscosity index (VI) is an empirical, unitless number indicating the effect of temperature change on the kinematic viscosity of the oil The higher the VI of an oil, the lower its tendency to change viscosity with temperature. Dielectric cooling fluids with lower VI such as, for example, napthenic mineral oil, tend to be thinner at transformer operating temperatures and thus dissipate the generated heat very effectively whereas the fluids with high VI such as, for example, natural ester oils comprising saturated esters, tend to have lower viscosity at low temperatures and therefore the fluid reaches quickly to expected service temperature during a cold startup. Natural vegetable oils in general have high viscosity index value (>200) compared to synthetic esters and mineral oils.

High temperature properties such as flash point and fire point are critical properties of a dielectric fluid. The flash point represents the temperature of the fluid that will result in an ignition of a fluids' vapors and the fire point represents the temperature of the fluid at which combustion occurs when exposed to air and an ignition source. Dielectric cooling fluids of the present invention meet specifications for less flammable liquids that qualify them as K-class materials, which is the highest fire performance standard for dielectric fluids. Cooling fluids of the present invention have a fire point of at least 300° C. as determined by ASTM D-92, which is the standard for K-class materials.

One other important desirable feature for a dielectric fluid is good aging stability, which is primarily associated with oxidative stability over time. Oxidation is a critical factor in the aging of a dielectric fluid and it is particularly important for a fluid used in a free breathing transformer, versus one used in a sealed transformer. Good oxidative stability minimizes the formation of sludge and acid which can improve electrical conduction, ensure acceptable heat transfer, and preserve system life.

Fluids comprising natural esters typically have a higher rate of oxidation than do mineral oils, and will typically polymerize when exposed to the atmosphere and heat. Therefore, conventional practice is that natural ester fluids are not recommended for free breathing transformers. In the practice of the present invention, dielectric cooling fluids that are oxidatively stable compared to conventional fluids comprising natural esters are obtained by blending natural oils having some degree of unsaturation with the renewably sourced synthetic polyol esters having no unsaturation as described herein.

In one embodiment of the present invention, improved dielectric fluid compositions comprising unsaturated natural oils and renewably sourced synthetic polyol esters are obtained by blending the components in a manner to control the iodine number of the blended composition, wherein the blended composition has an iodine number of 100 or less. An iodine number of less than 100 can be indicative of a cooling fluid that is oxidatively stable under the conditions of use. The iodine number is an indication of the degree of unsaturation present in the compositions described herein.

Natural oils include naturally occurring antioxidants such as tocopherols. However, the natural antioxidants that are present in natural oils are typically not as effective in stabilizing the oils relative to synthetic antioxidants. As a result, it can be conventional to add one or more synthetic antioxidants such as, for example: 2,6-di-t-butyl-p-cresol (DBPC), also known as butylated hydroxytoluene (BHT); butylated hydroxyanisole (BHA); propyl gallate; or t-butylhydroquinone (TBHQ) to natural ester dielectric fluids in order to improve the oxidative stability of the fluid. In some applications, however, it can be desirable to use dielectric fluids with no added synthetic oxidation inhibitors or use only a trace amount of inhibitors.

The fluids of the present invention have excellent oxidative stability, as indicated by the Oil Stability Index (OSI), even in the substantial absence of synthetic antioxidants, that is, where no synthetic antioxidants are added to the fluid composition. Uninhibited cooling fluids obtained according to the present invention can be used alone or can be added to another uninhibited dielectric fluids for use in both sealed and free breathing electrical equipment. For the purposes of the present invention, excellent oxidative stability is indicated by an OSI induction time of at least 20 hours, measured at 130° C. according to the methods of the American Oil Chemists Society (AOCS method 12b-92).

Uninhibited dielectric fluid blends as described herein comprise renewably sourced saturated polyol esters and high monounsaturated acid based natural esters, and these dielectric cooling fluids provide good chemical stability even when essentially free from synthetic antioxidants. In the practice of the present invention, a dielectric fluid is “uninhibited” if it comprises less than 0.08 wt % of a synthetic antioxidant, based on the weight of the fluid. However, if desired, synthetic additives—including aromatic anti-gassing additives, metal passivators, anti-foaming agents, electrostatic charging tendency depressants, and pour point depressants—can be added to the uninhibited fluids to enhance the stability further. A fluid of the present invention is said to be “inhibited” if it comprises greater than 0.08 wt % antioxidant but does not comprise more than 0.4 wt % total of synthetic antioxidant. Inhibited fluids can comprise any effective amount of other synthetic additives.

In one aspect of the present invention, uninhibited blends of synthetic esters of the present invention with at least one natural oil having about 75 mol % or greater monounsaturated ester content demonstrate a surprising stability, as indicated by an induction time as determined from the OSI of the blend that is longer than that of either of the uninhibited individual components. The uninhibited blends demonstrate a synergistic effect of blending the synthetic esters with a natural ester, whereby the OSI is increased relative to either of the individual components. Particularly, for uninhibited blends comprising 50 wt %, or particularly 70 wt % or more of the synthetic ester or more particularly uninhibited blends comprising about 80 wt % or more of the synthetic ester, or blends comprising 90 wt % or more of the synthetic ester an OSI that is surprisingly enhanced can be obtained.

In another aspect of the present invention, blends of synthetic esters and natural oils can demonstrate improved oxidative stability wherein the synthetic ester is refined to an acid number of less than about 0.07 mg KOH/g ester prior to blending with the natural oil. Refining, or purifying, the synthetic esters of the present invention prior to blending can improve properties of the blended composition, such as reducing the power factor, for example, and enhance the performance of the blends when used as dielectric fluids such as, for example, the volume resistivity. Treatment of the synthetic ester to remove impurities such as unreacted hydroxyl compounds, unreacted acids, particularly unsaturated acids or esters, can improve the performance of the synthetic esters and of blends comprising the esters.

A synthetic ester suitable for use in the practice of the present invention has an acid number according to ASTM D-974 of less than about 0.05 mg KOH/gram, preferably the acid number is less than about 0.03, and most preferably the acid number is about 0.01 mg KOH/gram or less. A commercially available synthetic ester having a higher than desired acid number can be treated to reduce the acid number to a level that provides a fluid that is useful as a dielectric fluid.

Purification of the fluids can be carried out by treating either the individual components or blends thereof with silica gel, activated carbon, basic alumina—or a combination of any two or all three of these—and results in an improved dielectric fluid relative to the untreated fluid. The treatment of the synthetic ester can be supplemented by heating the fluid to a temperature of from about 50° C. to about 150° C. during the treatment. Particularly, a treated fluid of the present invention comprises a synthetic ester having less than 3000 ppm of unreacted or partially reacted polyol, preferably less than 1500 ppm unreacted polyol and more preferably less than 500 ppm of unreacted polyol. Most preferably, a synthetic ester useful in the practice of the present invention comprises less than from about 50 to about 0 ppm of unreacted or partially reacted polyol.

Purified dielectric fluids of the present invention have a power factor, as determined by ASTM D-924, of less than about 0.5% at 25° C. and less than about 5% at 100° C. Further, the purified dielectric fluids of the present invention have a volume resistivity, as determined by ASTM D-1169, of greater than 10¹¹ ohm cm at 25° C.

The gassing tendency of a dielectric fluid, i.e. its tendency to absorb or evolve gasses under electrical stress, can affect the performance of liquid-filled transformers, cables and capacitors. Gassing tendency can be measured by ASTM D2300, wherein a decrease or increase in pressure indicates the fluid behavior under this electrical stress. Low gassing performance is highly desirable because a liquid having a low gassing tendency tends to generate less gasses and/or absorb any evolved gasses better, which can be desirable, particularly in a closed system. The American Society for Testing Materials has developed ASTM Standard D3487-00 which sets a limit for gassing tendency—as measured by ASTM D2300-8—of +30 μL/min for transformer cooling fluids. The International Electro-technical Commission (IEC) does not set a standard for gassing tendency of an insulating fluid, but suggests a maximum of +5 μL/min, as measured by IEC60628, for special applications.

In one embodiment of the present invention, dielectric fluids of the present invention are formulated to control the gassing tendency of the fluids so that it is within the range of from +30 to −30 μL/min, as measured by ASTM D2300-8, by a process of blending at least one dielectric fluid having a positive gassing tendency with a natural ester having a negative gassing tendency. The gassing tendency of the blended dielectric fluids described herein are controlled without the use of aromatic anti-gassing additives, which are used in conventional practice to control the gassing behavior of dielectric fluids.

The dissipation factor is a measure of the dielectric losses in fluid which in turn indicates the amount of energy dissipated as heat. The dissipation factor value must be as low as possible. Natural esters and synthetic ester insulating fluids usually have higher dissipation factors than non-polar mineral insulating oils especially at elevated temperatures. The typical values for the fluids of the present invention are less than about 0.5% at 25° C. and less than about 5.0% at 100° C. If the unaged fluids exceed these values indicating the presence of soluble polar contamination, the fluids can be refined to eliminate or reduce the levels of contaminants.

Dielectric constant (Dk) is defined as the amount of electrostatic energy which can be stored per unit volume per unit potential gradient and it can be measured for dielectric fluid by ASTM D924. The conventional mineral oil has dielectric constant about 2.2 and the solid cellulose insulation has about 4.5. The dielectric constants of natural ester and polyol esters are higher than mineral oil and are in the range of about 2.5 to 4.5 at 25° C. Increasing the dielectric constant, Dk, of liquid insulation in transformers and matching them to that of the solid insulation, balances the insulation system and improves the utilization of the mixed dielectric without increasing the stress in the oil channels. In one aspect of the present invention, the ratio (Dkᵣ) of the dielectric constants of the cooling fluid to the insulating solid material is engineered to be greater than 0.5, or can be in the range of from 0.5 to about 1.0. Liquid insulation with a high Dk yield savings in design and operation of transformers. It is an aspect of the present invention that the dielectric fluids of the present invention can be formulated so that their dielectric constant values are closer to solid insulation materials such as cellulose, Nomex® or cellulose-Nomex® blend.

In another embodiment of the present invention, the synthetic polyol ester comprises a glycerol oligomer ester, wherein the ester is the product obtained after esterification of a glycerol oligomer or an oligomeric mixture thereof. Glycerol oligomers, for the purposes of the present invention, include diglycerol up to hexaglycerol oligomers, and mixtures thereof. One of the advantages of using di-, tri-, or higher glycerol oligomer esters (GOE) in the practice of the present invention is that glycerol oligomer esters have higher dielectric constant (about 4.5) than natural oils, which typically have a dielectric constant of about 3.1. Therefore, it is an aspect of the present invention to provide a method for controlling or adjusting the dielectric constant of a dielectric fluid to a range wherein the fluid dielectric constant more closely matches that of solid insulation paper. The process comprises the step of mixing a GOE with a natural ester or other renewably sourced synthetic polyol ester or with mineral oil, or with a blend comprising mineral oil. For the purposes of the present invention, glycerol oligomers include from 2 to 6 glycerol repeat units, preferably 2 or three glycerol repeat units, or mixtures thereof, and have from 4 to 8 hydroxyls. Preferably at least about 90% of the oligomer is diglycerol.

In still another embodiment, blends of renewably sourced synthetic esters with mineral oil can be effective as dielectric cooling fluids. In a particular embodiment, the mineral oil is severely hydro-treated naphthenic oil or severely hydro-treated isoparaffinic oil. By “severely hydro-treated” it is meant that the mineral oil is subjected to a sequential process of (1) hydrocracking, (2) hydroisomerization, and (3) hydrogenation as described in U.S. Pat. No. 6,790,386 for example. Mineral oils treated in this manner can be biodegradable. Blends of the present invention with mineral oils do not, however, require a aromatic gassing additive to provide a dielectric fluid having a low or a negative gassing tendency, that is a gassing tendency of less than about +30 to about −30 μL/min. Blends can comprise from at least about 25 wt %, or alternatively from about 50 wt % to about 99 wt %, or from about 75 to about 95 wt % mineral oil and from about 1 to about 75 wt % of a renewably sourced composition of the present invention, including blends thereof with natural oils having high monounsaturated ester content. Mineral oil can be blended with either (1) a natural oil or blend thereof, particularly one having significant monounsaturated ester content (2) a synthetic polyol ester or blend thereof, or (3) a blend comprising both a natural oil as in (1) and a synthetic ester as in (2). Mineral oil blends as described herein can be formulated according to the methods of the present invention to provide a blended insulating fluid having a balance of desirable properties such as: improved oxidative stability, low pour point, low viscosity, low viscosity index and improved gassing tendency, while potentially improving cost effectiveness with fluids other than mineral oil. The blends of the present invention are formulated to meet standards set to provide fluids that are stable and effective in use as dielectric fluids but do not require a gassing additive to meet the gassing tendency standards.

Additives can be optional to improve the performance of the cooling fluids described herein. In some embodiments, the improvements observed are surprising in view of the absence of additives. For example, oxidative stability can be improved to a surprising degree without the use of antioxidants by blending synthetic esters and natural oils. Additives can be used, however, if desired. Depending on the composition of the blend, the blended compositions of the present invention may or may not require added synthetic additives such as antioxidants, pour point depressants, anti-gassing aromatic agents, metal passivators, anti-foaming agents, and electrostatic charging tendency depressants.

For example, in one embodiment, the blended compositions of the present invention comprise a renewably sourced saturated synthetic polyol ester as the major component, from about 51 to about 99 wt % of the blend, and a natural ester as the minor component for use in open breathing transformers, from about 1 wt % of the blend to about 49 wt % of the blend, with additives optionally added.

In another embodiment, the blended compositions of the present invention comprise the renewably sourced synthetic polyol ester as minor component, from about 1 wt % of the blend to about 49 wt % of the blend, and natural based ester as major component, from about 51 to about 99 wt % of the blend for use in sealed transformers, with additives optionally added.

In another embodiment, the blended composition of the present invention comprises either naphthenic or isoparaffinic mineral oil as major component, from about 51 to about 99 wt % of the blend, and the minor component, from about 1 wt % of the blend to about 49 wt % of the blend, comprises a blend of the renewably sourced synthetic saturated polyol ester and high oleic acid based triglyceride for use in power transformers, with additives optionally added.

If antioxidants are included, a high molecular weight phenolic antioxidant such as IRGANOX® 259 can be included, or TBHQ can be added or BHT can be added for blends comprising mineral oil. It can be advantageous to match a specific antioxidant with a particular major component of the fluid blend for optimal results. For example, blends comprising a synthetic ester as the major component of the blend are substantially better stabilized by antioxidants such as IRGANOX® 259 than by TBHQ. Blends comprising a natural ester as the major component are substantially better stabilized by TBHQ. It is surprising that blends of the synthetic antioxidants were not as effective in improving the stability of the blended fluid compositions as when an individual antioxidant is matched with the appropriate major component of the fluid blend.

For a dielectric fluid to be labeled as a bio-based fluid, the United State Department of Agriculture (USDA) has established a minimum standard of 66% renewable carbon or bio-based carbon content for a synthetic polyol ester and 95% renewable carbon or bio-based carbon content for a natural ester. The compositions of the present invention have greater than 66% renewable carbon or bio-based carbon content.

In one embodiment, the blend compositions of the present invention are useful in liquid-filled transformers comprising insulation paper selected from normal Kraft paper, thermally upgraded cellulose paper, Nomex® paper and cellulose/Nomex® blend paper.

### EXAMPLES

### General

The following materials were used in the examples:

Refined, bleached, and deodorized high oleic soybean oil (RBD HOS oil) containing triglycerides of the following fatty acids: palmitic acid (6.5 wt %), stearic acid (4.15 wt %), oleic acid (73.9 wt %), linoleic acid (8.77 wt %), and linolenic acid (2.94 wt %) was obtained according to U.S. Pat. No. 5,981,781.

Commodity soybean oil was obtained from Homestead Farms, Des Moines, Iowa.

Inhibited Type II Mineral oil, Univolt N 61B, was obtained from ExxonMobil, Fairfax, Va.

Uninhibited mineral oil, Nytro Taurus, was obtained from Nynas.

A blend of Caprylic and Capric (C8/C10) fatty acid was obtained from Acme Hardesty. Heptanoic acid (C7) was obtained from Alfa Aesar (Heysham, England)

Lauric acid (>98%) was used as received from Alfa Aesar.

Glycerol and trimethylolpropane (97%) were obtained from Aldrich Company (Milwaukee, Wis.).

Diglycerol was obtained from Solvay Performance Chemicals (Houston, Tex.)

Glyceryl tricaprylate-caprate (GTCC) is sold under the tradename Grindsted® MCT 60 X by DuPont. Trimethylolpropane tricaprylate-caprate (TTCC) (WAGLINOL 3/13480) and pentaerythritol tetracaprylate-caprate (PTCC) (WAGLINOL 4/13680) were obtained from Industrial Quimica Lasem, S.A.Barcelona, Spain.

Silica gel was obtained from EMD Chemicals.

Activated carbon (PWA powder) was obtained from Calgon.

Basic alumina (G250) was obtained form BASF Company.

Iodine values of natural esters were determined by quantifying the unsaturation using proton NMR.

Turbidity measurements on the compositions were carried out using a nephelometric turbidimeter (MicroTPW, Model 20000, Scientific Inc. FT. Myers, Fla.) monitors light reflected off the suspended particles. The NTU (Nephelometric Turbidity Unit) numbers represent the transparency of a solution; the lower numbers represent higher transparency.

Color was measured as APHA values (Platinum-Cobalt System) according to ASTM D-1209.

### Comparative Examples 1-3

The commercially available synthetic saturated polyol esters (GTCC, TTCC and PTCC) were evaluated to determine their suitability as basestock for use in transformers. These esters include the same mixture of (C8/C10) fatty acids but differ only in the identity of the polyol used to prepare the esters. The measured properties of these polyol esters are reported in Table 1.

TABLE 1
Properties Of Commercial Polyol Ester Fluids

| | ASTM | Comparative | Comparative | Comparative |
|---|---|---|---|---|
| | Method | Example 1 | Example 2 | Example 3 |
| Polyol ester | | GTCC | TTCC | PTCC |
| Renewable source | calculated | 100 | >80 | >85 |
| carbon, % | | | | |
| Acid number, | D-974 | 0.012 | 0.07 | 0.087 |
| mgKOH/g | | | | |
| Viscosity at | D-445 | 14.7 | 20.4 | 32.2 |
| 40° C., cSt | | | | |
| Pour Point, ° C. | D-97 | −12 | −44 | −12 |
| Flash Point, ° C. | D-92 | 240 | 272 | 278 |
| Fire Point, ° C. | D-92 | 272 | 294 | 322 |
| Dielectric | D-1816 | 72 | 64 | 65 |
| breakdown, kV | | | | |
| Dielectric | | | | |
| constant | | | | |
| at 25° C. | D-924 | 3.68 | 3.41 | 3.13 |
| at 100° C. | | 3.26 | 3.08 | 2.91 |
| Resistivity | | | | |
| at 25° C., | D1169 | 1.76 × 10¹² | 3.48 × 10¹¹ | 9.98 × 10¹² |
| ohm cm | | | | |
| at 100° C. | | 0.81 × 10¹¹ | 8.44 × 10¹⁰ | 2.46 × 10¹¹ |
| Power factor | | | | |
| at 25° C., % | D-924 | 0.389 | 3.14 | 0.139 |
| at 100° C. | | 22.6 | 25.8 | 5.86 |
| Gassing tendency, | D-2300 | +39.3 | +35.3 | +37.0 |
| μL/min | | | | |

From the data shown in Table 1, none of the commercially available polyol ester fluids tested have the combination of desired properties (low viscosity, high dielectric constant, low pour point, K-class standards for flash and fire points, low power factor, low gassing tendency) for a dielectric fluid. All three polyol esters exceeded the upper limit of positive gassing tendency of +30 μL/min as specified by ASTM D3487-00 and thus are not suitable as dielectric fluids for the practice of the present invention.

### Comparative Example 4

### Preparation of Trimethylolpropane Tricaprylate-Caprate (TTCC)

To a 1 L three necked round bottom flask fitted with a Dean-Stark trap and condenser, magnetic stirrer, nitrogen inlet, thermocouple and external heating jacket was added 1,1,1-trimethylolpropane (131.4 g, 0.98 mol), and 60/40 C8/C10 fatty acid blend (499.5 g, 3.21 mol). The mixture was heated to 225° C. with stirring at 400 rpm and a nitrogen blanket. The pressure was reduced to 75 mmHg in steps of approximately 100 mmHg over 5 hours and held for a further 6 hours during which time distillate collected in the trap.

The Dean-Stark trap was replaced with a condenser fitted with a collection flask and the nitrogen inlet to the headspace was replaced with a nitrogen purge. The reaction was heated to 225° C. at 5 mmHg pressure with a fast nitrogen purge and stirring at 400 rpm and the distillate was collected over 7 h yielding trimethylolpropane tricaprylate-caprate (523.5 g, 98.3%).

### Example 1

### Preparation of Trimethylolpropane Tricaprylate-Caprate-Laurate

To a 1 L three-necked round bottom flask fitted with Dean-Stark trap and condenser, magnetic stirrer, nitrogen inlet, thermocouple and external heating jacket was added 1,1,1-trimethylolpropane (104.2 g, 0.8 mol), 60/40 C8/C10 fatty acid blend (332.0 g, 2.1 mol) and C12 fatty acid (83.0 g, 0.4 mol). The mixture was heated to 225° C. with stirring at 400 rpm and a nitrogen blanket. The pressure was reduced to 75 mmHg in steps of approximately 100 mmHg over 5 hours and held for a further 6 hours during which time distillate collected in the trap. The Dean-Stark trap was replaced with a condenser fitted with a collection flask and the nitrogen inlet to the headspace was replaced with a nitrogen purge. The reaction was heated to 225° C. at 5 mmHg pressure with a fast nitrogen purge and stirring at 400 rpm and the distillate was collected over 7 h yielding trimethylolpropane triester (429.9 g, 97.9%).

The properties of this fluid were measured and provided in Table 2, together with the same properties for the lab synthesized ester fluid from C8/C10 fatty acid blend (Comparative Example 4).

TABLE 2
Properties Of Synthesized Polyol Eser Fluid

| | ASTM | Comparative | |
|---|---|---|---|
| Property | method | Example 4 | Example 1 |
| Fire Point, ° C. | D-92 | 298 | 304 |
| Viscosity at 40° C., cSt | D-445 | 20.1 | 21.6 |
| Pour Point, ° C. | D-97 | <−50 | −47 |

### Example 2

### Purification of a Commercial Synthetic Polyol Ester (TTCC)

To a 5 L three necked round bottom flask fitted with a nitrogen purge, thermocouple, heater and magnetic stirrer was added trimethylolpropane tricaprylate/caprate (3005.9 g, Waglinol 3/13480), activated carbon (30.0 g, Calgon, PWA powdered,) and basic alumina (30.0 g, BASF, G250). The system was heated to 130° C. with stirring at 250 rpm and nitrogen passing through the head space for 90 minutes. The fluid was allowed to cool and passed through a coarse frittered funnel layered with ½″ Celite 545 (approximately 30 g, EMD) atop ½″ silica gel 60 (approximately 30 g, Alfa Aesar) using reduced pressure and a nitrogen blanket yielding purified trimethylolpropane triester (2793.0 g, 92.9%). The properties of the purified triester in comparison with as received commercial ester are reported in Table 3.

TABLE 3
Properties of Purified and Unpurified TTCC Ester Fluids

| | ASTM | Comparative | |
|---|---|---|---|
| | Method | Example 2 | Example 2 |
| Polyol ester | | As received | Purified |
| Moisture, ppm | D-1533 | 114 | 52 |
| Color, APHA | | 91 | 10 |
| Turbidity, NTU | | 1.30 | 0.05 |
| Acid number, mgKOH/g | D-974 | 0.07 | 0.01 |
| OSI at 110° C., h | | 84 | 96 |
| Pour Point, ° C. | D-97 | −44 | −50 |
| Flash Point, ° C. | D-92 | 272 | 268 |
| Fire Point, ° C. | D-92 | 294 | 300 |
| Dielectric breakdown, kV | D-877A | 64 | 75 |
| Dielectric constant | | | |
| at 25° C. | D-924 | 3.41 | 3.39 |
| at 100° C. | | 3.08 | 3.07 |
| Resistivity | | | |
| at 25° C., ohm cm | D1169 | 3.48 × 10¹¹ | 1.16 × 10¹³ |
| at 100° C. | | 8.44 × 10¹⁰ | 3.12 × 10¹¹ |
| Power factor | | | |
| at 25° C., % | D-924 | 3.14 | 0.092 |
| at 100° C. | | 25.8 | 4.93 |
| Gassing tendency, μL/min | D-2300 | +35.3 | +31.7 |

The purification of the commercial product as received improved the quality of the product and its electrical properties. Significant reduction in power factor and increase in volume resistivity were observed for the purified product. The oxidative stability of the fluid was improved by the purification procedure.

### Example 3

### Preparation of Diglycerol Ester or Glycerol Oligomer Ester (GOE)

In a 22 L reaction flask was equipped with an overhead stirrer, a thermocouple, a port to have nitrogen blown into the liquid, and a distillation column & condenser. The flask was flushed with nitrogen. diglycerol (3.1 Kg), heptanoic acid (1.2 Kg), octanoic acid (6.8 Kg), and decanoic acid (4.0 Kg) were loaded into the flask and nitrogen was blown into the mixture. The reaction was slowly heated up to 150° C. and heated for 4 hours, then heated between 150-224° C. for another 11 hours. A total of about 1.25 L of water were collected. After the reaction mixture was cooled to room temperature, the distillation column was removed and a distillation head was directly connected to the flask. The reaction mixture was distilled at a pressure of 1 torr until the pot temperature reached 217° C., at which temperature the unreacted acids (694 g) were recovered. After being cooled to room temperature, the reaction mixture was diluted with hexanes (7 L) and transferred to a 30 L bottom valved resin kettle. The material was then washed with a mixture of saturated NaCl (1 L), NaOH solution (10%, 2 L) and DI water (3 L), NaOH (10%, 3×2 L), and with DI water (5×3 L). The hexane solvent was removed on a rotary evaporator to form a crude product. The crude product was passed through a thin (¾″) of silica gel and the filtrate was dried on vacuum at 110° C. for 1 hour to give oil (11.8 Kg). The oil sample was treated with activated carbon (2%) at 110° C. under 1 torr vacuum for 1 hour. After being cooled to room temperature, the carbon was removed by filtration through a silica gel bed to give almost colorless oil. About 3.2 L of the filtrate was passed through a 10″ silica gel column and about 3 L of eluent was collected. The FAME analysis indicated the following contents: heptanoic acid (8.6%), octanoic acid (55.2%), decanoic acid (35.9%), and Lauric acid (0.2%).

The FAME analysis was conducted as described below.

FAME Profile Test

Stock Preparation

For this test first several stock solutions were prepared:

Oil for analysis: 30 mg/ml in toluene.

Stock acid—cool methanol (50 mL) and slowly add acetyl chloride (5 mL).

Stock salt—1M aqueous sodium chloride

Stock internal standard—5 mg/mL in toluene, the internal standard is a triglyceride which will react along with the oil sample to form methyl esters there by minimizing the effect of less than 100% conversion of all the oil into methyl esters because the internal standard's reaction rate should be close to that of the oil's reaction rate. The standard was purchased form Nu-Chek Prep, Inc. catalog code T-145, which is tripentadecanoin (C15:0).

Sample Run

In a 20 mL vial equipped with a small stir bar, combine stock oil (100 μL), stock internal standard (100 μL), and stock acid (1 mL). Heat vial with stirring to 80° C. for 1 hour; upon cooling open vial and add stock aqueous sodium chloride (1 mL) and hexanes (300 μL). Mix thoroughly and pipette whole solution into a narrow vial (˜3 mL) to allow easier layer separation.

Pipette off ˜300 uL of the organic solution (top-layer) into a GC vial equipped with insert.

GC Method Specs

Method established using GLC-461 reference standard mixture of 32 different methyl esters C4:0 to C24:1 to identify retention times. Column: Supelco 24152 Omegawax 320 30 m long, diameter 320 μm, film thickness 0.30 μm. Oven ramp: Initial temp 160° C. holds for 5 minutes, then increase at 2° C./min to 220° C. and hold for 10 minutes, then increase at 20° C./min to 240° C. and hold for 5 minutes. The carrier gas is helium. Injection port 250° C., with pressure 11.55 psi; split ratio 50:1 split flow: 77.8 mL/min; total flow: 82.3 mL/min. Initial flow rate 1.6 ml/min with 11.56 psi. Flame ionization detector used set at 270° C., hydrogen flow 35 mL/min; air flow 400 mL/min; Mode constant column+makeup flow; combined flow 32.0, make up gas is helium.

Data Analysis Description Examples of Math

$${MEO}_{x} = methyl\_ester \_from \_oil$$

$$x = the\_specific \_species \_of \_methyl \_ester$$

$$Methyl\_ester \_relitive \_Weight \% = \frac{{MEO}_{x} ( mg )}{{\sum }_{x = 1}^{n} {MEO}_{x} ( mg )} \times 100$$

$$Methyl\_ester \_ \frac{mg}{g} = \frac{{MEO}_{x} ( mg )}{\frac{mg\_oil \_to \_start}{1000}}$$

$${MEO}_{x} ( mg ) = \frac{{GCPeakArea}_{x}}{{GCPeakArea}_{C15 \text{:} 0}} \times \frac{TotalVolumeWithSolvent ( μ L )}{1000} \times {ISTD}_{C 15 \text{:} 0} ( \frac{mg}{mL} )$$

The methyl ester relative weight percent for methyl ester from the oil is calculated. Three repeats of each of the in process samples are made using the same stock oil solution. From each of these samples, the FAME profile is established and an average for three repeats is calculated for each methyl ester present along with the standard deviation.

TABLE 4
Properties of glycerol oligomer ester

| Property | Example 3 |
|---|---|
| Viscosity at 40° C., cSt | 27.3 |
| Viscosity at 100° C., cSt | 5.88 |
| Flash point, ° C. | 288 |
| Fire point, ° C. | 300 |
| Pour point, C | −42 |
| Power factor at 21° C. | 0.17 |
| Power factor at 100° C. | 4.9 |
| Dielectric constant | 4.53 |
| Gassing tendency, μL/min | +36.9 |

### Oxidative Stability of Fluids

### Comparative Examples 5-8

The oxidative stability of the two neat synthetic polyol ester fluids (Comparative examples 5 & 6) and two natural ester fluids such as high oleic soybean oil (HOS) and commodity soybean oil (Soy) (Comparative Examples 7 & 8) in the absence of added antioxidants were evaluated by oil stability index (OSI). The OSI determinations were made at 130° C. using the Oxidative Stability Instrument (Omnion, Inc, Rockland, Mass.) using official AOCS methods (AOCS Method Cd 12b-97). Samples were run in duplicate and the average values for each fluid are presented in Table 5.

### Examples 4-7

Blends were prepared by mixing the purified TTCC fluid of Example 2 with high oleic soybean oil at weight ratio ranging from 10 to 50%.

### Example 8

Separately, another blend was prepared by mixing 90 wt % of GOE of Example 3 with 10 wt % high oleic soybean oil.

### Example 9

A blend was prepared by mixing 90 wt % of GOE of Example 3 with 10 wt % of commodity soybean oil.

The oxidative stability of the above blends in the absence of synthetic antioxidants was evaluated by OSI and compared with neat fluids in Table 5. The amount of unsaturation in high oleic soybean and commodity soybean was determined from NMR and the unsaturation in the blend was calculated based on the amount natural ester present and are reported as iodine value.

TABLE 5
OSI induction times for neat and blended ester fluids

| | Fluid | | | | |
|---|---|---|---|---|---|
| | composition | Unsaturation | OSI times in hours | | |
| Example | (% weight) | Iodine value | Run 1 | Run 2 | Average |
| Comparative | TTCC (100) | 0 | 14.5 | 13.6 | 14.1 |
| Example 5 | | | | | |
| Comparative | GOE(100) | 0 | 4.4 | 4.2 | 4.3 |
| Example 6 | | | | | |
| Comparative | Soy (100) | 132 | 1.40 | 1.45 | 1.4 |
| Example 7 | | | | | |
| Comparative | HOS (100) | 85 | 6.4 | 6.6 | 6.5 |
| Example 8 | | | | | |
| Example 4 | TTCC/HOS | 8.5 | 45.7 | 44.2 | 44.9 |
| | (90/10) | | | | |
| Example 5 | TTCC/HOS | 17 | 27.8 | 27.6 | 27.7 |
| | (80/20) | | | | |
| Example 6 | TTCC/HOS | 25.5 | 20.4 | 20.5 | 20.4 |
| | (70/30) | | | | |
| Example 7 | TTCC/HOS | 42.5 | 13.2 | 13.3 | 13.2 |
| | (50/50) | | | | |
| Example 8 | GOE/HOS | 8.5 | 35.8 | 36.1 | 36 |
| | (90/10) | | | | |
| Example 9 | GOE/Soy | 13.2 | 7.7 | 7.6 | 7.7 |
| | (90/10) | | | | |

Saturated polyol esters demonstrate higher OSI induction time compared to natural esters, and the genetically modified high oleic soybean oil had longer induction time when compared to conventional commodity soybean oil

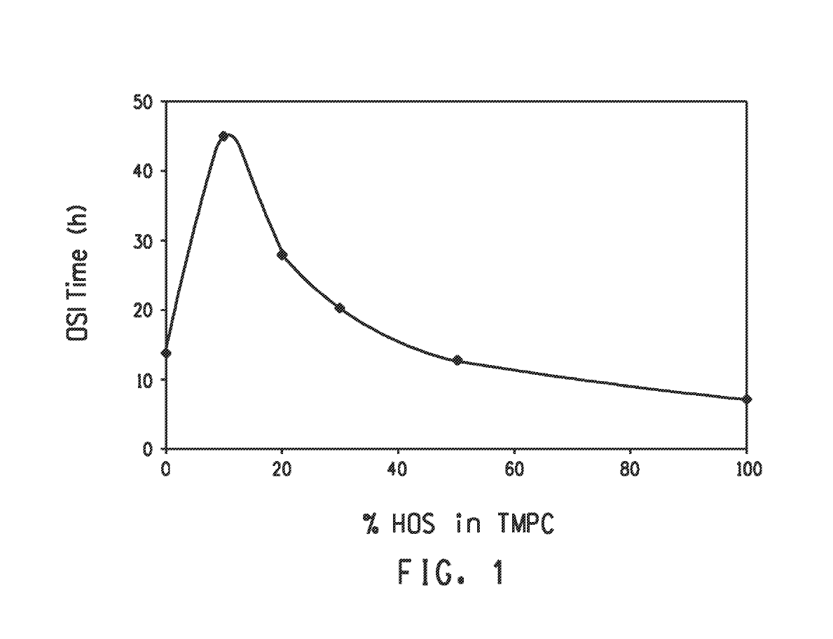

The effect of high oleic soybean oil amount in the blend comprises of TTCC on OSI induction time was shown in FIG. 1. Highest oxidative stability of the fluid blend was reached at about 10 wt % of HOS oil, and the stability of the blend fluid gradually decreased with increase in HOS oil and reached the stability of neat polyol ester at about 50 wt % HOS oil.

Gassing Tendency of the Fluids

Gassing tendency of the neat high oleic soybean oil and commodity soybean oil (Comparative Examples 7 & 8), and the two synthetic polyol ester fluids (Comparative Examples 2 and 6) under the electrical stress were tested in Doble lab according to ASTM D2300, and the values are reported in Table 6. The natural vegetable oils had gas absorbing (negative gassing) tendency and synthetic saturated polyol esters had gas evolving (positive gassing) tendency under the electrical stress.

### Examples 10-12

As shown in Table 6, blends were prepared by mixing renewably sourced synthetic saturated polyol ester fluids with natural esters without adding any additives and the gassing tendency of these blends was tested and compared with neat ester fluids.

As shown in Table 6, the addition of natural ester fluid such as high oleic soybean (HOS) oil or commodity soybean oil (Soy) to the saturated TMP based triester (TTCC) or glycerol oligomer based ester (GOE), surprisingly changed the characteristics of the synthetic saturated fluids from gas evolving to gas absorbing (Comp Example 2 and 6 and Examples 10-12).

TABLE 6
Gassing Tendency Of The Neat And Blend Fluids
in the absence of additives

| | | Gassing |
|---|---|---|
| | | tendency |
| Example | Fluid | μL/min |
| Comp Example 7 | Soy (100%) | −33.7 |
| Comp example 8 | HOS (100%) | −39.1 |
| Comp example 2 | TTCC (100%) | +35.3 |
| Comp example 6 | GOE (100%) | +36.9 |
| Example 10 | TTCC/HOS (80%/20%) | −24.7 |
| Example 11 | TTCC/Soy (20%/80%) | −41.8 |
| Example 12 | GOE/Soy (90%/10%) | −3.7 |

The effect of synthetic antioxidant additives on the gassing tendency of the neat and blend fluids was investigated. As shown in Table 7, the additives had no impact on either negative gassing tendency fluid (Comparative Ex 8 & 9) or positive gassing tendency fluid (Comparatives Examples 2). Surprisingly, the additives showed remarkable effect on the blends. The non-linear effect of reduction in gassing tendency was also evident for the blends (Examples 13, 14, 16).

When the addition was reversed i.e. when a small amount of saturated polyol ester was added to natural ester, the negative gassing tendency rate was slightly reduced from −39.1 to −36.2 (Example 18), the effect is not as significant as with the addition of natural ester to polyol ester.

TABLE 7
Effect of additives on gassing tendency of the neat and ester blend fluids

| | | | Gassing | |
|---|---|---|---|---|
| | | | tendency | Change |
| Example | Fluid | Antioxidant | μL/min | % |
| Comp example 8 | HOS (100%) | none | −39.1 | |
| Comp example 8a | HOS (100%) | 0.3% | −41.2 | −5 |
| | | TBHQ/0.9% | | |
| | | Irganox 259 | | |
| Comp example 2 | TTCC (100%) | none | +35.3 | |
| Comp example 2a | TTCC (100%) | 0.2% TBHQ | +35.3 | 0 |
| Comp example 9 | TMP ester of | none | −20.7 | |
| | HOS | | | |
| Comp example 9a | TMP ester of | 0.2% TBHQ | −20.9 | −1 |
| | HOS | | | |
| Example 13 | TTCC/HOS | 0.2% TBHQ | +17.6 | |
| | (95%/5%) | | | |
| Example 14 | TTCC/HOS | 0.2% TBHQ | −0.3 | |
| | (90%/10%) | | | |
| Example 15 | TTCC/HOS | none | −24.7 | |
| | (80%/20%) | | | |
| Example 16 | TTCC/HOS | 0.2% | −18.5 | 25 |
| | (80%/20%) | | | |
| Example 17 | Purified TTCC/ | 0.2% TBHQ | −12.5 | |
| | HOS (80%/20%) | | | |
| Example 18 | TTCC/HOS | 0.2% TBHQ | −36.2 | |
| | (20%/80%) | | | |
| Example 19 | TTCC/Soy | none | −41.8 | |
| | (20%/80%) | | | |
| Example 20 | TTCC/Soy | 0.2% TBHQ | −30.8 | −26 |
| | (20%/80%) | | | |
| Example 21 | GOE/Soy | none | −3.7 | |
| | (90%/10%) | | | |

Mixed Esters and Mineral Oil Blends:

The gassing tendency of inhibited mineral oil, Univolt N61B (Comp Ex 10) and uninhibited mineral oil, Nytro Taurus (Comparative Ex 11) was tested and the values were found to be in the acceptable range. Nonetheless, the gassing tendency of these fluids was improved by the addition of either high oleic soybean oil (Example 22 & 23)) or blend of synthetic ester and high oleic soybean oil (Example 24) without adding anti-gassing additives. Once again, the reduced positive gassing tendency was observed for the blend fluid in the presence of antioxidant additive, as shown in Example 25 in Table 8.

Therefore, the fluids of the present invention can be tailored to have good chemical stability with respect to oxidation and electric stress by blending synthetic polyol ester fluids with appropriate amounts of natural esters in particular with high oleic soybean oil.

TABLE 8
Gassing tendency of blends of Mineral Oil (MO) with esters

| | | | Gassing | |
|---|---|---|---|---|
| | | | tendency | Change |
| Example | Fluid | Antioxidant | μL/min | % |
| Comp Ex 10 | Mineral oil (100%) | inhibited | +20 | |
| Example 22 | MO/HOS (90%/10%) | inhibited | +12 | |
| Comp Ex11 | Mineral oil | none | +10 | |
| Example 23 | Uninhibited MO/HOS | None | −5.1 | |
| | (80%/20%) | | | |
| Example 24 | 80% MO/16% | none | +5.3 | |
| | TMPC/4% HOS | | | |
| Example 25 | 80% MO/16% | 0.3% BHT | +2.6 | 51 |
| | TMPC/4% HOS | | | |

### Renewably Sourced Synthetic Polyol Ester and Natural Ester Blends

### Example 26

An uninhibited blend fluid was formulated by mixing only 90 wt % TTCC and 10 wt % HOS oil and this fluid is essentially free from synthetic additives including aromatic anti-gassing additives, synthetic antioxidants, passivators and pour point depressants. The properties of the formulated fluid are listed in Table 9.

### Example 27-28

Inhibited fluid formulations were also prepared by blending the renewably sourced synthetic polyol ester (purified TTCC) as a major basestock and natural ester (HOS) as a minor (additive) component. The resulting fluids have excellent balanced properties as shown in Table 9 and are suitable as insulating fluids for use in transformers, in particular, in open breathing power transformers.

TABLE 9
Properties of Synthetic and Natural Ester Blended Fluids

| | ASTM | | | |
|---|---|---|---|---|
| Property | method | Example 26 | Example 27 | Example 28 |
| Composition | | TTCC/HOS | TTCC/HOS | TTCC/HOS |
| | | (90%/10%) | (80%/20%) | (70%/30%) |
| Antioxidant | | None | 0.2% TBHQ | 0.2% TBHQ |
| additive | | | | |
| Renewable | Calculated | 83 | 85 | 87 |
| sourced | | | | |
| carbon, % | | | | |
| Moisture, ppm | D-1533 | 26 | 17 | 23 |
| Iodine value | | 8.5 | 17.1 | 25.5 |
| OSI time | | | | |
| at 110° C., hr | | >100 | >100 | >100 |
| at 130° C. | | 44.9 | 101 | 83.3 |
| Viscosity | | | | |
| at 40° C., cSt | D-445 | 22.0 | 24 | 25 |
| at 100° C. | | 5.06 | 5.3 | 5.87 |
| Pour Point, ° C. | D-97 | −45 | −38 | −33 |
| Flash Point, ° C. | D-92 | 276 | 280 | 275 |
| Fire Point, ° C. | D-92 | 284 | 300 | 300 |
| Dielectric | D-877 | 46 | 74 | 58 |
| breakdown, kV | | | | |
| Dielectric | | | | |
| constant | | | | |
| at 25° C. | D-924 | 3.29 | 3.30 | 3.30 |
| at 100° C. | | 3.00 | 2.98 | 2.99 |
| Resistivity | | | | |
| at 25° C., | D-1169 | 1.69 × 10¹³ | 1.48 × 10¹³ | 1.48 × 10¹³ |
| ohm cm | | | | |
| at 100° C. | | 7.46 × 10¹¹ | 1.51 × 10¹¹ | 1.51 × 10¹¹ |
| Power factor | | | | |
| at 25° C., % | D-924 | 0.052 | 0.066 | 0.066 |
| at 100° C. | | 2.6 | 2.59 | 2.99 |

The data in Table 9 shows the flexibility to alter the properties of the fluids and thereby their performance as dielectric fluids by blending the renewably sourced synthetic ester with a natural ester.

### Comparative Example 12

The commercially available dielectric fluid based on natural ester oil was tested and the properties of this fluid are reported in Table 10. As the data indicate, this fluid did not meet the desired properties of viscosity, pour point, oxidative stability and gassing tendency.

### Example 29

An inhibited fluid formulation with improved properties was prepared by blending the natural ester, soybean oil, as a major component, a mixture of two synthetic polyol esters (TTCC & GTCC) as minor components, 0.2% antioxidant and 1.0% pour point depressant. As shown in Table 10, this fluid in comparison with commercial fluid had excellent oxidative stability, low gassing tendency, superior low temperature fluid properties, and met the K fire safety class. Once again, it was seen that the oxidatively stable fluid has a low gassing tendency as well. This fluid is useful both in sealed and open distribution and power transformers.

TABLE 10
Properties of Natural Ester Blended With Polyol Ester Fluids

| | ASTM | Comparative | |
|---|---|---|---|
| Property | method | Example 12 | Example 29 |
| Composition | | Commercial | 70%/20%/10% |
| | | natural ester | Soy/TTCC/ |
| | | fluid | GTCC |
| Antioxidant, % | | Unknown | 0.2 |
| Renewable sourced carbon, % | calculated | >98 | >95 |
| Moisture, ppm | D-1533 | 176 | 26 |
| Iodine value | | 130 | 92 |
| OSI time at 110° C., hr | | 9.0 | 91.9 |
| Viscosity | | | |
| at 40° C., cSt | D-445 | 35.9 | 31.4 |
| at 100° C. | | 8.66 | 7.19 |
| Pour Point, ° C. | D-97 | −22 | −36 |
| Time to solidification | | 1.5 h | Liquid after 14 |
| at −22 ± 2° C. | | | weeks |
| Flash Point, ° C. | D-92 | 334 | 294 |
| Fire Point, ° C. | D-92 | 354 | 310 |
| Dielectric breakdown, kV | D-877 | 71 | 44 |
| Dielectric constant | | | |
| at 25° C. | D-924 | 3.14 | 3.16 |
| at 100° C. | | 2.84 | 2.87 |
| Resistivity | | | |
| at 25° C., ohm cm | D-1169 | 7.56 × 10¹² | 6.31 × 10¹² |
| at 100° C. | | 3.72 × 10¹¹ | 3.24 × 10¹¹ |
| Power factor | | | |
| at 25° C., % | D-924 | 0.126 | 0.10 |
| at 100° C. | | 3.25 | 4.15 |
| Gassing tendency, μL/min | D-2300 | −44.9 | −13.6 |

The formulations of the present invention are not limited to the compositions described, further optimization of the formulations can be done to improve the performance of the fluid.

### Example 30

An uninhibited dielectric fluid was prepared by blending a severely hydrotreated uninhibited insulating mineral oil (80% by weight, Nytro Taurus), 16% by weight of polyol ester(trimethylolpropane tricaprylate/caprate), and 4% by weight of high oleic soybean oil. No synthetic additives were added to the fluid. The properties of the uninhibited dielectric fluid blend were tested and compared with the neat mineral oil (comparative example 13) in Table 11.

TABLE 11
Properties of Mineral oil/Polyol Ester/Natural ester Fluid Blend

| | ASTM | Comparative | |
|---|---|---|---|
| Property | method | Example 13 | Example 30 |
| Composition | | Mineral oil | 80%/16%/4% |
| | | 100% | MO/TTCC/HOS |
| Synthetic Antioxidant, % | | none | none |
| Renewable sourced | calculated | 0 | 20 |
| carbon, % | | | |
| Acid number, mg KOH/g | D-974 | 0.007 | 0.02 |
| Viscosity | | | |
| at 40° C., cSt | D-445 | 10.08 | 11.2 |
| at 100° C. | | 2.47 | 2.69 |
| Pour Point, ° C. | D-97 | −48 | −50 |
| Flash Point, ° C. | D-92 | 158 | 162 |
| Fire Point, ° C. | D-92 | 168 | 176 |
| Dielectric breakdown, kV | D-877 | 20 | 24 |
| Dielectric constant | | | |
| at 25° C. | D-924 | 2.32 | 2.41 |
| at 100° C. | | 2.12 | 2.27 |
| Resistivity | | | |
| at 25° C., ohm cm | D-1169 | 8.78 × 10¹³ | 4.70 × 10¹³ |
| at 100° C. | | 7.53 × 10¹² | 2.56 × 10¹² |
| Power factor | | | |
| at 25° C., % | D-924 | 0.015 | 0.10 |
| at 100° C. | | 0.102 | 4.15 |
| Gassing tendency, uL/min | D-2300 | +10 | +5.3 |

As seen in Table 11, the addition of 20 wt % mixed esters to the mineral oil did not alter the properties of the mineral oil significantly. Nevertheless, the addition of polar, stable ester fluid blend to the non-polar mineral oil may enhance the reliability, the sustainability, and the life of the power transformers due to the superior stability of the solid insulation in the dielectric fluid of the present invention. Upon aging, this fluid when compared to neat mineral oil may have more tolerance towards moisture and thermal and electrical stresses, keeps the solid insulation paper dry, lower sludge formation and lower acid generation. In addition, the biodegradability of the fluid will be higher than the mineral oil.

Table 12 reports the oxidative stability of the ester blends in the presence of antioxidants and compares with neat ester fluids.

TABLE 12
OSI induction times for neat and blended ester fluids

| Fluid | TBHQ/Irganox 259 | OSI (hours) | |
|---|---|---|---|
| % wt | (ppm/ppm) | 110° C. | 130° C. |
| HOS, 100% | 0/0 | | 6.5 |
| | 1000/0 | | 12.9 |
| | 0/1000 | | 7.5 |
| Soy, 100% | 0/0 | 6.5 | |
| | 3000/0 | 77.4 | |
| | 0/3000 | 11.4 | |
| TTCC, 100% | 0/0 | | 16.6 |
| | 500/0 | | 37.8 |
| | 0/500 | | >200 |
| TTCC/HOS, 80/20% | 0/0 | | 27.7 |
| | 500/0 | | 53.9 |
| | 0/500 | | 94.9 |
| | 250/250 | | 81.1 |
| Soy/TMPC/GTCC, 70/20/10% | 0/0 | 7.1 | |
| | 1000/0 | 65.2 | |
| | 0/1000 | 14.8 | |
| | 500/500 | 49.6 | |

### Example 31

### Diglyceride Impurity and Power Factor (Pf) Reduction in Commercial MCT60X Sample

1H NMR analysis on an “as received” MCT60X sample indicated it contained about 3800 ppm of diglycerides. After silica gel treatment (see Example 2), the purified MCT60X showed that its diglyceride impurities were reduced to below the detection limit based on 1H NMR analysis. Accordingly, the Pf of the samples were reduced significantly (see Table 13).

TABLE 13

MCT60X

| | As received | Purified |
|---|---|---|
| Pf (%) at | 22.6 | 2.2 |
| 100° C. | | |
| Diglyceride | ~3800 ppm | 0 ppm |
| impurity | | |
| content based | | |
| on H NMR | | |

What is claimed is:

1. A composition useful as a dielectric fluid, the composition being a blend comprising: (i) from about 50 wt % to about 99 wt % of mineral oil, based on the weight of the fluid; (ii) from about 1 wt % to about 50 wt % of a triacylglycerol natural oil obtained from a natural source, consisting essentially of long chain fatty acid esters having greater than about 75 mol % monounsaturation; and (iii) optional additives;
wherein the blend—without added aromatic anti-gassing additives—has a reduced gassing tendency compared to the gassing tendency of component (i).

2. The composition of claim 1 wherein the triacylglycerol comprises 20 mol % or less of polyunsaturated esters.

3. The composition of claim 2 wherein the blend comprises from about 5 to about 30 wt % triacylglycerol.

4. The composition of claim 3 wherein the triacylglycerol is selected from soybean oil, sunflower oil, safflower oil, olive oil, and canola oil.

5. The composition of claim 4 wherein the blend comprises from about 10 to about 20 wt % of the triacylglycerol.

6. The composition of claim 5 wherein the blend comprises from about 15 to about 20 wt % of the triacylglycerol.

7. The composition of claim 6 wherein the blend has a pour point as determined by ASTM D-97 of about −20° C. or lower.

8. The composition of claim 1 wherein the mineral oil is severely hydro-treated isoparaffinic oil or severely hydro-treated naphthenic oil.

9. The composition of claim 1 wherein the gassing tendency of the blend is in the range of from about −30 μL/min to about +30 μL/min as determined according to ASTM D-2300.

10. An electrical apparatus comprising a dielectric fluid of claim 1.
